(19) United States
(12) Patent Application Publication
(10) Pub. No.: US 2026/0128397 A1
(43) Pub. Date: May 7, 2026

(54) HIGH-VOLTAGE BATTERY ADAPTED FOR DISCONNECT OF INTERNAL HIGH-VOLTAGE ELECTRICAL COMPONENTS

(71) Applicant: Daimler Truck North America LLC, Portland, OR (US)

(72) Inventors: Matthew RODRIGUES, Oregon City, OR (US); Connor Kurtz, Portland, OR (US)

(21) Appl. No.: 19/379,585

(22) Filed: Nov. 4, 2025

Related U.S. Application Data
(60) Provisional application No. 63/716,674, filed on Nov. 5, 2024.

(51) Int. Cl. H01M 10/42; H01M 10/48; H01M 50/505

(52) U.S. Cl. CPC H01M 10/425; H01M 10/488; H01M 50/505; H01M 2200/103; H01M 2220/20

(57) ABSTRACT

High-voltage batteries with integrated high-voltage electrical components and electrical disconnects. High-voltage battery electric systems and mobile transports that include the same. In aspects, high-voltage batteries can include a main enclosure, a subcompartment within the main enclosure, and an electrical disconnect. The electrical disconnect can be configured so that it can be operated, e.g., through interaction with electrically-isolated components, to disconnect a high-voltage electrical circuit in the sub-compartment then allowing high-voltage electrical components in the sub-compartment to be accessed and manipulated without electrical potential. Methods of manufacturing, installing, servicing, and replacing high voltage batteries are also disclosed.:

### CROSS-REFERENCE TO RELATED APPLICATION

This patent application claims the benefit of U.S. Provisional Application No. 63/716,674, filed on Nov. 5, 2024, titled “HIGH-VOLTAGE BATTERY ADAPTED FOR DISCONNECT OF INTERNAL HIGH-VOLTAGE ELECTRICAL COMPONENTS.” The disclosure of the prior application is hereby incorporated by reference in its entirety.

### BACKGROUND

High-voltage batteries include one or more internal battery cells and high-voltage electronics (e.g., controllers, fuses, current sensors). To maximize space—especially in vehicles—these electronics are often integrated within a main battery enclosure. This compact integration can place high-voltage components close proximity to one another or near structures with electrical potential and those components periodically require inspection, service, repair, or replacement. Accessing them in such confined areas often demands special tools, training, and certified procedures, increasing service time, cost, and complexity and, in some cases, resulting in disposal of otherwise serviceable batteries.

### TECHNICAL FIELD

The present disclosure relates generally to high-voltage batteries, e.g., those used in vehicles, e.g., freight trucks.

### SUMMARY

The following presents a simplified summary of one or more implementations of the present disclosure to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to an integrated high-voltage battery, including therein: a sub-compartment that encloses one or more high-voltage electrical components; and an electrical disconnect operable to disconnect the one or more high-voltage electrical components from a high-voltage electrical circuit prior to opening the sub-compartment.

In some aspects, the techniques described herein relate to an integrated high-voltage battery, including: an enclosure, including therein: a first sub-compartment that encloses one or more low-voltage electrical components; a second sub-compartment that encloses one or more high-voltage electrical components; and an electrical disconnect operable to disconnect the one or more high-voltage electrical components from a high-voltage electrical circuit and thereby allow the second sub-compartment to be opened.

In some aspects, the techniques described herein relate to an integrated high-voltage battery, including: an enclosure; a panel that reversibly couples to the enclosure to thereby enclose one or more high-voltage electrical components; and an electrical disconnect operable for disconnecting the one or more high-voltage electrical components from a high-voltage electrical circuit, wherein operating the electrical disconnect de-couples the panel from the enclosure, and/or wherein de-coupling the panel from the enclosure operates the electrical disconnect.

### BRIEF DESCRIPTION OF THE DRAWINGS

FIG. 1 is a schematic view of a high-voltage battery in exploded form, in in accordance with an example aspect of the present disclosure;

FIG. 2 is a schematic view of high-voltage battery of FIG. 1 in assembled form, in accordance with an example aspect of the present disclosure;

FIG. 3 is schematic view of an internal configuration of a high-voltage battery, in accordance with an example aspect of the present disclosure;

FIGS. 4A-4C are schematic views of an electrical disconnect for a high-voltage battery, in accordance with an example aspect of the present disclosure;

FIG. 5 is a schematic view of an interlocking configuration for a panel that encloses high-voltage electrical components, in accordance with aspect an example of the present disclosure;

FIG. 6 depicts a touch protected opening of an electrical disconnect, in accordance with aspects of the present disclosure;

FIG. 7 depicts an internal configuration of a high-voltage battery with distinct compartments, in accordance with aspects of the present disclosure;

FIG. 8 depicts another internal configuration of a high-voltage battery with distinct compartments, in accordance with aspects of the present disclosure;

FIG. 9 depicts another internal configuration of a high-voltage battery with distinct compartments, in accordance with aspects of the present disclosure;

FIG. 10 is a block diagram of a method of servicing a high-voltage battery, in accordance with aspects of the present disclosure; and

FIG. 11 depicts an example of a mobile transport that can incorporate aspects described herein.

### DETAILED DESCRIPTION

In current high-voltage battery systems, accessing the high-voltage electronics (controllers, fuses, sensors, contactors) often leaves parts of the system energized, demanding specialized tools and certifications, increasing service time and cost, and sometimes forcing disposal of otherwise serviceable assemblies. The mixed proximity of high-voltage and low-voltage components further complicates access and heightens shock risk.

The present disclosure provides an integrated, serviceable electrical disconnect built into the battery enclosure that forces isolation of the high-voltage circuit before exposure. Aspects of the disclosure include an internal sub-compartment for high-voltage electronics that cannot be opened until the disconnect is operated; a bus bar with electrically-insulated attachment structures (e.g., insulated fasteners) that allow coupling/decoupling while remaining isolated from electrical potential; and interlocking panels where operating the disconnect enables panel removal (or panel removal operates the disconnect). Touch-safe features (e.g., IP-rated openings) protect contacts when the bus bar is removed, and layouts can segregate low-voltage components into independently accessible compartments.

Collectively, these features reduce required training and tools, shorten service time, improve technician safety, and lower costs and waste by enabling targeted repair or replacement. The architecture supports multiple configurations (separate or panel-integrated disconnects, multiple disconnect points for cells vs. electronics) and is applicable across vehicle and mobile transport platforms, extending battery operational life while improving serviceability.

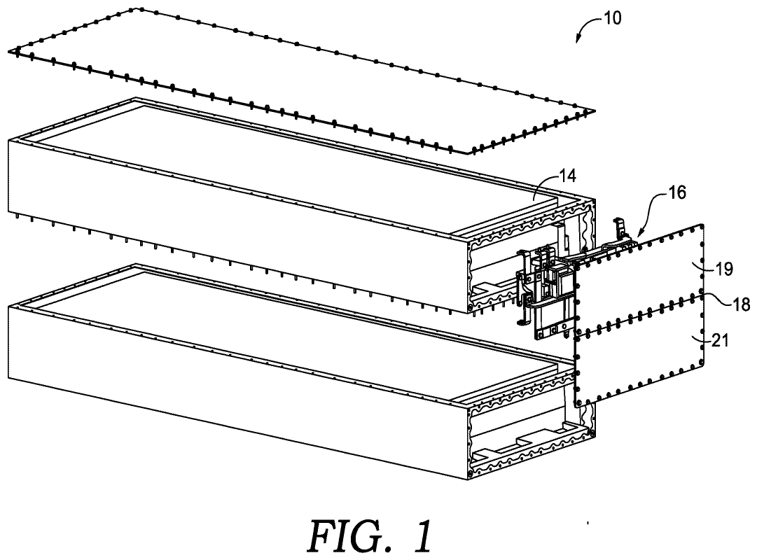

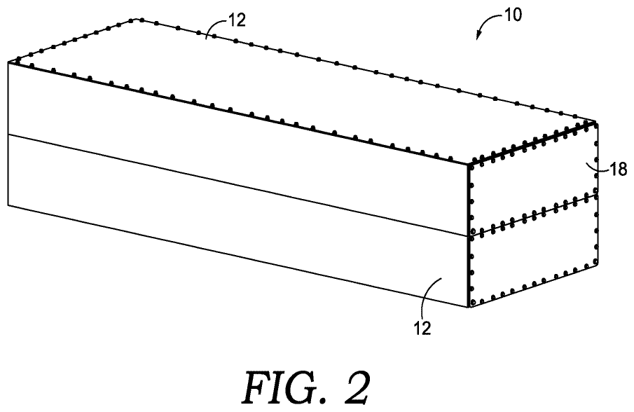

Referring now to FIG. 1, a high-voltage battery 10 is shown, in accordance with aspects of the present disclosure. FIG. 1 shows the high-voltage battery 10 in exploded form. FIG. 2 shows the high-voltage battery 10 in assembled form. The battery 10 depicted in FIGS. 1 and 2 illustrates one non-limiting example of high-voltage battery that can incorporate the aspects described herein.

The high-voltage battery 10 includes a main enclosure 12 as best shown in FIG. 2. The main enclosure 12 generally encloses a plurality of integral battery cells 14 as identified in FIG. 1. The main enclosure 12 also encloses (e.g., within its volume and/or within an enclosure thereof) a plurality of electrical components 16 that support electrical operation of the high-voltage battery 10. The electrical components 16 can include high-voltage and low-voltage electrical components, arranged in discrete or combined configurations according to different aspects described herein. FIGS. 1 and 2 also show a removable portion 18 of the main enclosure 12 that can be opened, de-coupled, and removed to allow access to the electrical components 16 inside the battery 10. In the depicted example, the removable portion 18 includes separately removable panels 19 and 21. As used herein, ‘high-voltage’ can be about 60 V or higher (e.g., about 60-1,200 V), and ‘low-voltage’ can be below about 60 V.

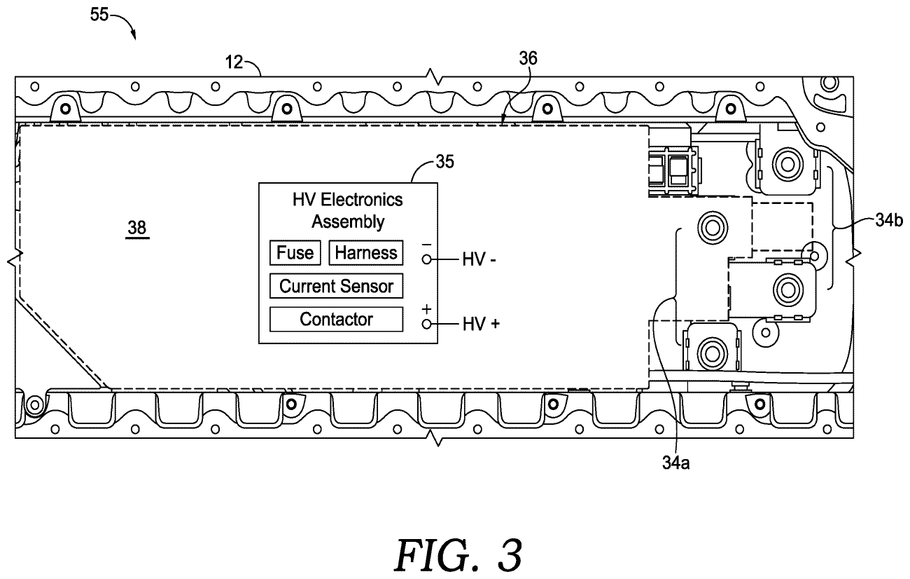

In general, the battery 10 shown in FIGS. 1 and 2, like others described herein, can be adapted so that certain high-voltage electrical components inside the main enclosure 12 can be disconnected from a high-voltage electrical circuit before those components are accessed and manipulated. A number of non-limiting configurations of a high voltage battery that support such functionality are depicted and described herein. FIG. 3 depicts one non-limiting example of such a configuration.

Referring now to FIG. 3, a configuration of electrical components 55 inside a high-voltage battery (e.g., the battery 10 shown in FIGS. 1 and 2), is depicted in accordance with aspects of the present disclosure. With reference to FIGS. 1 and 2, FIG. 3 shows a view generally into the battery 10 through the removable portion 18, e.g., at electrical components behind panel 19 or behind panel 21.

FIG. 3 depicts, as part of the configuration of electrical components 55, an electrical disconnect 34. In the non-limiting example of FIG. 3, the electrical disconnect 34 is implemented as a pair of similarly-configured electrical disconnects 34a and 34b (collectively, electrical disconnect 34). In some aspects, an electrical disconnect can be implemented via a single device in other aspects, via multiple devices as in FIG. 3. FIG. 3 shows the electrical disconnects 34a, and 34b with their corresponding bus bars de-coupled and removed.

The electrical disconnect 34 is operable to disconnect a subset of high-voltage electrical components inside the battery 10 that may require inspection, service, repair, or replacement. Examples of such components include controllers, sensors (e.g., current sensors), fuses, breakers, wiring harnesses, contactors, battery management electronics, and the like, as depicted by the example high-voltage electronics assembly 35 in FIG. 3. The high-voltage electronics assembly 35 generically represents components that are enclosed under and/or inside a sub-compartment 36 identified in FIG. 3.

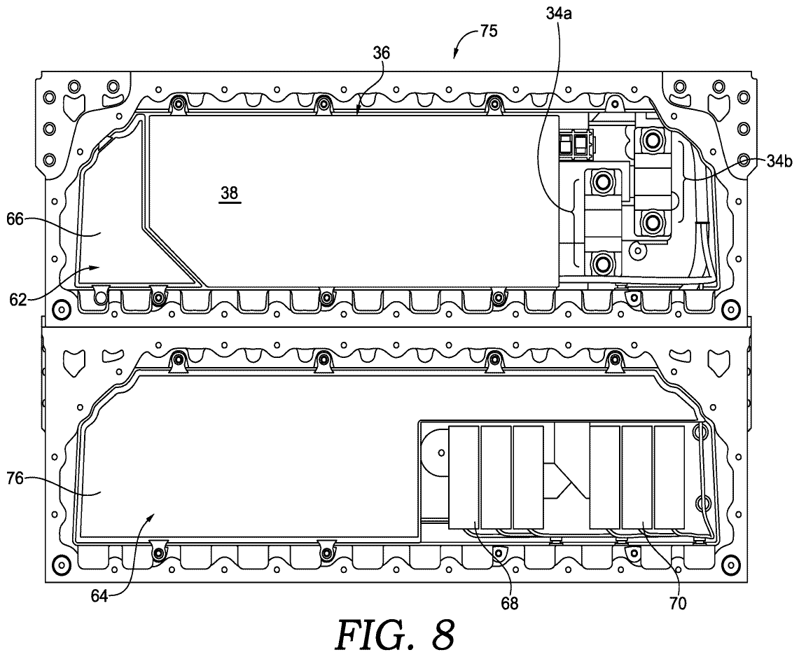

The electrical disconnect 34 can be located inside the main enclosure 12 but outside the sub-compartment 36, as shown in FIG. 3. This allows the electrical disconnect 34 to be operated to disconnect high-voltage electrical components inside the sub-compartment 36 from a high-voltage electrical circuit, before those components are accessed, contacted, and manipulated. Once the electrical disconnect 34 is operated to interrupt the high-voltage electrical circuit, the sub-compartment 36 can be opened to expose the components therein (e.g., the electronics assembly 35 shown in FIG. 3). More specifically, once the electrical disconnect 34 is operated, a panel 38 (represented by dotted lines in FIG. 3) can be removed to expose the electronics assembly 35 for inspection, service, repair, or replacement. The panel 38 is also identified in FIG. 8. In some aspects, the electrical disconnect 34 is operated before opening the sub-compartment 36. In some aspects, operating the electrical disconnect 34 may be required to open the sub-compartment 36, e.g., to mechanically de-couple and remove the panel 38. In some aspects, operation of the electrical disconnect 34 allows components in the sub-compartment 36 to be disconnected from the high-voltage electrical circuit separately from other parts of the battery, e.g., the battery cells 14.

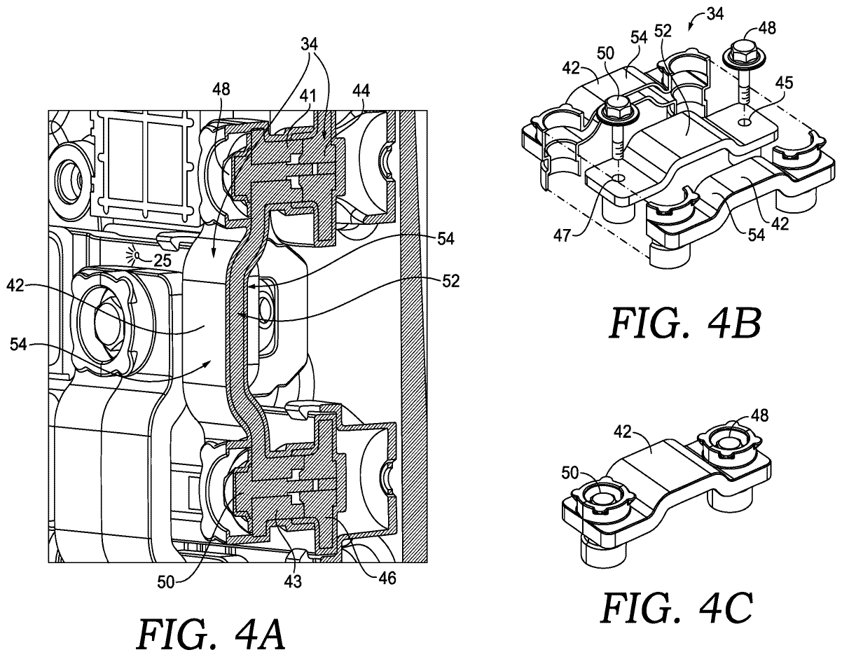

Referring now to FIGS. 4A-4C, one possible configuration of an electrical disconnect (e.g., electrical disconnect 34, or specifically, 34a or 34b thereof in FIG. 3), is shown in accordance with aspects of the present disclosure. FIGS. 4A-4C illustrate one example electrical disconnect but many others are contemplated herein including those with different components, materials, and operational configurations. FIG. 4A shows the electrical disconnect 34 in an installed configuration, e.g., as it might be installed inside the main enclosure 12 of the battery 10 as in FIG. 3. The electrical disconnect 34 includes a bus bar 42 formed partially of an electrically-conductive material and partially of an electrically-insulated material. The bus bar 42 includes a pair of electrically-conductive end structures 41 and 43 that can engage and electrically bridge a pair of electrical contacts 44 and 46 to complete a high-voltage electrical circuit through one or more high-voltage electrical components (e.g., those inside the sub-compartment 36 shown in FIG. 3).

The electrical disconnect 34 is configured so that the bus bar 42 can be releasably or reversibly attached against the pair of electrical contacts 44 and 46. To enable this, an electrically insulated attachment structure is provided to secure the bus bar 42 against the pair of electrical contacts 44 and 46. In the example of FIG. 4A-4C, the electrically insulated attachment structure is a plurality of electrically insulated fasteners 48 and 50 that extend through corresponding openings 45 and 47 in the bus bar 42 and into engagement with the pair of electrical contacts 44 and 46, thereby holding the electrically conductive end structures 41 and 43 against the contacts to complete a circuit. The bus bar 42 includes a portion 52 that extends between the electrically conductive end structures 41 and 43 and is formed of an electrically conductive material to transfer high-voltage current. The bus bar 42 also includes a portion 54 formed from an electrically insulated material that does not transfer high-voltage current. The portion 54 is located so that the electrically insulated attachment structure (e.g., fasteners 48 and 50) can secure the bus bar 42 without exposure to the electrical current passing through portion 52. In aspects, the fasteners 48 and 50 can thread into the pair of electrical contacts 44 and 46 to maintain engagement, and can be unthreaded to allow de-coupling and/or removal of the bus bar 42 to interrupt the high-voltage electrical circuit. In some aspects, an indicator (e.g., indicator light 25) can be used to indicate whether the high-voltage electrical circuit has been interrupted.

In aspects, an electrically insulated material may cover surfaces of an electrical disconnect where electrical potential is not desired (e.g., the portion 54 of the bus bar 42 and/or the surfaces of the fasteners 48 and 50 shown in FIG. 4A-4C). For example, the surfaces may be coated, covered, or otherwise formed from plastic, silicon, rubber, ceramic, or another electrically insulating material such that no electrical potential is present at those surfaces. In some aspects, touch-protection is maintained in both mated and unmated conditions (e.g., IPxxB in each state) at the bus bar terminations and/or fastener interfaces.

FIGS. 4B and 4C depict the electrical disconnect 34 generally in isolation. FIG. 4B shows the electrically insulated portion 54 exploded outward, revealing the electrically conductive portion 52 that extends between the pair of electrically conductive end structures 41 and 43 configured to be secured into engagement with the pair of electrical contacts 44 and 46 as shown in FIG. 4A. The electrical disconnect 34 can be operated by extending the fasteners 48 and 50 through the openings 45 and 47 and rotating the fasteners into threaded engagement with the pair of electrical contacts 44 and 46. This provides a conductive path between the electrical contacts 44 and 46 through the portion 52. This process can be reversed to de-couple the bus bar 42 from the pair of electrical contacts 44 and 46 and thereby interrupt the high-voltage electrical circuit, e.g., so that the sub-compartment 36 shown in FIG. 3 can subsequently be opened. In some aspects, once de-coupled, the bus bar 42 can be biased into a displaced position from the electrical contacts 44 and 46 so that interruption of the electrical circuit is maintained until operation of the fasteners 48 and 50 restores it.

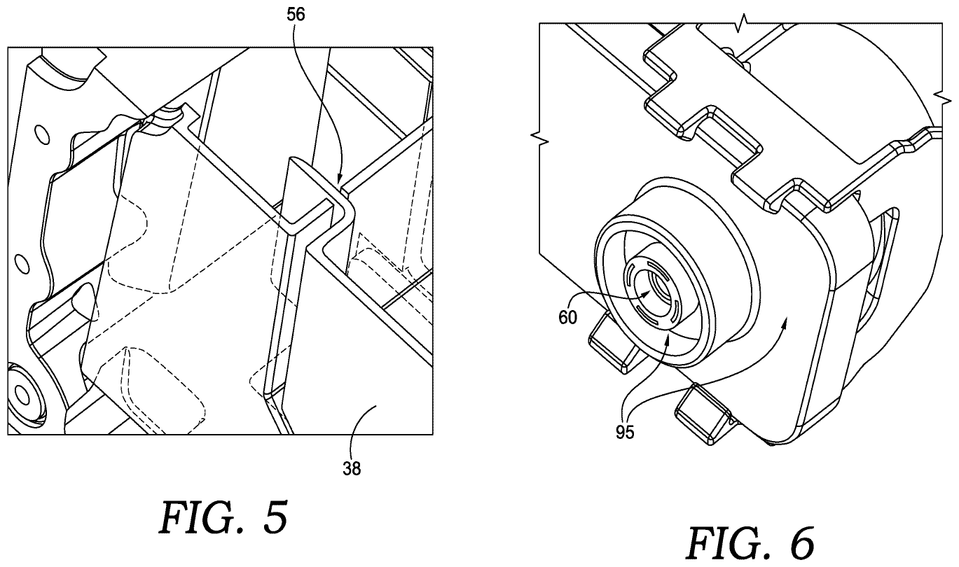

Looking now at FIG. 5, an example of an interlocking structure 56 used in connection with a panel (e.g., panel 38 in FIG. 8) that encloses a sub-compartment with high-voltage electronics is shown, in accordance with aspects of the present disclosure. “Panel,” as used herein, encompasses a broad range of structures, including traditional flat and non-flat panels, shields, covers, shrouds, and other planar or non-planar enclosure-like structures that can cover a sub-compartment containing high-voltage electrical components intended to be accessed only once a high-voltage electrical circuit is interrupted. Thus, while “panel” is frequently used herein, it refers to structures of different sizes and shapes, including two-dimensional and three-dimensional shapes.

Referring to FIG. 5, to help secure a panel in place over a sub-compartment with high-voltage electrical components, an interlocking structure (e.g., interlocking structure 56) can be incorporated. In some aspects, the panel cannot be removed until the electrical disconnect has been operated to open the high-voltage circuit, and conversely, decoupling the panel operates the electrical disconnect to open the circuit. The interlocking structure 56 can help maintain the panel in place until an electrical disconnect is operated to disconnect the electrical circuit. For example, in aspects, operating the electrical disconnect 34 to de-couple the bus bar 42 from the electrical contacts 44 and 46 also mechanically de-couples the panel 38 from covering the sub-compartment 36, thereby allowing the panel 38 to be removed. In aspects, the attachment for a bus bar can be used to physically secure an overlapping panel. For example, electrically insulated fasteners may extend through corresponding holes in a panel to secure it along with securing a bus bar. In aspects, removing the fasteners (e.g., 48 and 50) can allow a panel to be shifted in position and release the interlocking structure 56, thereby allowing the panel to be removed.

Referring to FIG. 6, a component 95 that can form part of an electrical disconnect is shown in accordance with aspects of the present disclosure. The component 95 includes an opening 60 to an electrical contact. In aspects, a bus bar (e.g., bus bar 42 shown in FIG. 4B) can be secured in place against the component 95 using an electrically insulated fastener (e.g., fastener 48 or 50). The electrically insulated fastener can be extended through the bus bar (as described in connection with FIG. 4A-4C) and then through the opening 60 into engagement with the electrical contact inside the component 95. FIG. 6 depicts how, upon removing the bus bar and the electrically insulated fastener, the opening 60 is exposed. However, the opening is sized, shaped, and configured such that it does not permit touch engagement (i.e., it is touch-protected), including when the contact is mated or unmated. For example, in aspects, such openings can be IPxxB-rated openings/terminals. The configuration described in connection with FIG. 6 can be implemented in any of the electrical disconnects or terminals described herein.

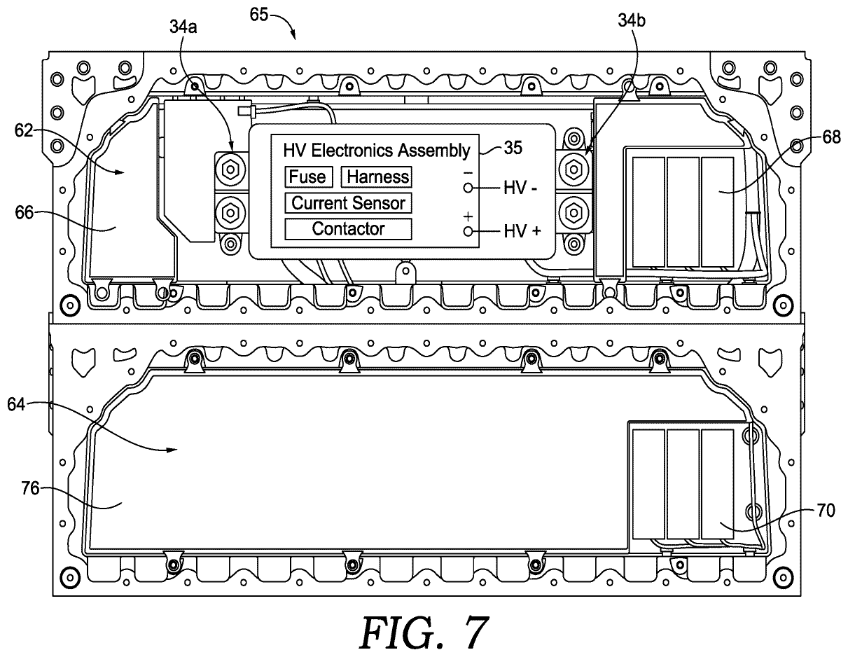

Referring to FIG. 7, another internal configuration of electrical components 65 inside an enclosure of a high-voltage battery (e.g., battery 10 depicted in FIGS. 1 and 2) is shown in accordance with aspects of the present disclosure. The internal configuration of electrical components 65 in FIG. 7 is similar to the configuration 55 in FIG. 3, with some distinctions. For example, distinct sub-compartments 62 and 64 are included in FIG. 7. In aspects, the sub-compartments 62 and 64 can be independently accessible, e.g., via separate panels (e.g., panels 19 and 21 in FIG. 1).

In FIG. 7, high-voltage electrical components that are not intended to be periodically serviced, and thus do not need to be readily accessible, are shielded behind affixed panels 66 and 76 that inhibit access. High-voltage electrical components that are intended to be periodically serviced (e.g., those of high-voltage electronics assembly 35) are located inside the sub-compartment 62. Proximate to the high-voltage electronics assembly 35 and within sub-compartment 62 is an electrical disconnect 34 (represented as similarly configured disconnects 34a and 34b, collectively electrical disconnect 34). The electrical disconnect 34 can be operated to interrupt the high-voltage electrical circuit passing through the electrical components of the high-voltage electronics assembly 35, thereby allowing those components to be manipulated. In additional or alternative aspects, a panel can be implemented with the electrical disconnect 34, as described in connection with FIG. 3. The panel can enclose the high-voltage electronics assembly 35 until the electrical disconnect 34 is operated to expose it.

In aspects, the sub-compartments 62 and 64 can include or be located adjacent to low-voltage electrical components 68 and 70 (as shown in FIG. 7) that can be serviced without operating the electrical disconnect 34. In some aspects, the low-voltage electrical components 68 and 70 may include a protective panel or may be open and accessible. In some aspects, the low-voltage electrical components 68 and 70 can be split between the sub-compartments 62 and 64 (as shown in FIG. 7). In other aspects, the low-voltage electrical components 68 and 70 can be consolidated into a single sub-compartment 62 or 64 (e.g., as shown in FIG. 8). In some aspects, the battery can additionally include a separate electrical disconnect operable to interrupt a high-voltage electrical circuit through one or more battery cells, independent of the electrical disconnect 34 that interrupts the circuit through the electronics assembly 35.

Referring to FIG. 8, an internal configuration of electrical components 75 inside an enclosure of a high-voltage battery (e.g., battery 10 depicted in FIGS. 1 and 2) is shown in accordance with aspects of the present disclosure. In FIG. 8, instead of locating high-voltage and low-voltage electrical components inside both sub-compartment 62 and sub-compartment 64, the components are generally separated into distinct compartments (e.g., sub-compartments 62 and 64), which can be configured to be independently accessed. In the configuration shown in FIG. 8, the low-voltage electrical components 68 and 70 are located substantially entirely within the independently accessible sub-compartment 64, and the high-voltage electrical components are located substantially entirely within the independently accessible sub-compartment 62. The low-voltage electrical components 68 and/or 70 can thus be accessed without operating the electrical disconnect 34 (i.e., the similarly configured disconnects 34a and 34b) that open the sub-compartment 62. Instead, the low-voltage components 68 and/or 70 can be accessed by opening or accessing the sub-compartment 64. FIG. 8 also depicts the panel 38 (identified by dotted lines in FIG. 3) installed over the sub-compartment 36, enclosing the high-voltage electronics assembly 35. In FIG. 8, the panel 38 is secured in place by components of the electrical disconnect 34 (e.g., bus bars shown in the installed position).

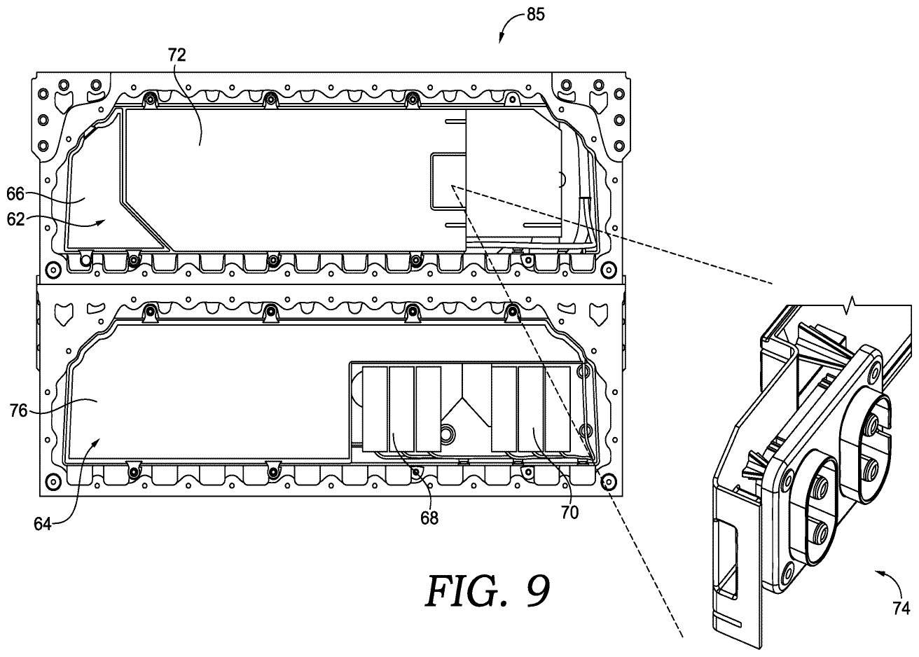

Referring to FIG. 9, an internal configuration of electrical components 85 located inside an enclosure of a high-voltage battery (e.g., battery 10 depicted in FIGS. 1 and 2) is shown in accordance with aspects of the present disclosure. In some aspects, touch-safe terminals (e.g., IPxxB) remain on the pack after removal of the panel so that energized upstream terminations are protected. The configuration of electrical components 85 is similar to, but distinct in some parts from, the configuration 75 shown in FIG. 8, as explained below.

In FIG. 8, a panel (e.g., panel 19 or 21 of the battery 10 of FIG. 1) is removed to expose the panel 38 and the electrical disconnect 34, which can be operated to interrupt a high-voltage electrical circuit, thus allowing access to the sub-compartment 36 behind panel 38 where high-voltage electrical components (e.g., of high-voltage electronics assembly 35) are located.

In FIG. 9, an electrical disconnect 74 is used instead of the electrical disconnect 34. The electrical disconnect 74 is configured to be integrated directly into a panel that encloses a sub-compartment containing high-voltage electrical components. In the example of FIG. 9, the electrical disconnect 74 is integrated into an internal panel 72. In other words, panel 72 is located behind a panel that opens a main enclosure of the battery (e.g., panel 19 or 21 of battery 10 in FIG. 1). To access and manipulate the high-voltage electrical components, the external panel (e.g., panel 19 or 21) is removed, and de-coupling panel 72 operates the electrical disconnect 74 to interrupt a high-voltage electrical circuit through the high-voltage components behind panel 72. In aspects, conversely, operating the electrical disconnect 74 de-couples panel 72. Panel 72 can then be removed to expose the high-voltage electrical components for inspection, service, repair, or replacement with no electrical potential. In some aspects, the electrical disconnect 74 can instead be built into an external panel (e.g., panel 19 or 21 of battery 10 shown in FIG. 1). In this configuration, de-coupling the external panel operates the electrical disconnect 74, after which the external panel can be removed to expose the high-voltage components inside the battery without electrical potential. In aspects, conversely, operating the electrical disconnect 74 de-couples the external panel. In some aspects, the electrical disconnect 74 can be integrated to be operable to de-couple an internal or external panel, but may be built into a different part of the enclosure (i.e., not directly into the internal or external panel, but rather into an adjacent structure).

In aspects, the electrical disconnect 74 can include similar components to those described in connection with FIG. 3-8, including touch-protected features. In some aspects, the electrical disconnect can alternatively be integrated into the enclosure separate from the panel In aspects, any of the panels described herein that are used to enclose high-voltage electrical components can instead have an integrated electrical disconnect (e.g., like electrical disconnect 74) rather than a separate electrical disconnect (e.g., like electrical disconnect 34 shown in FIG. 3).

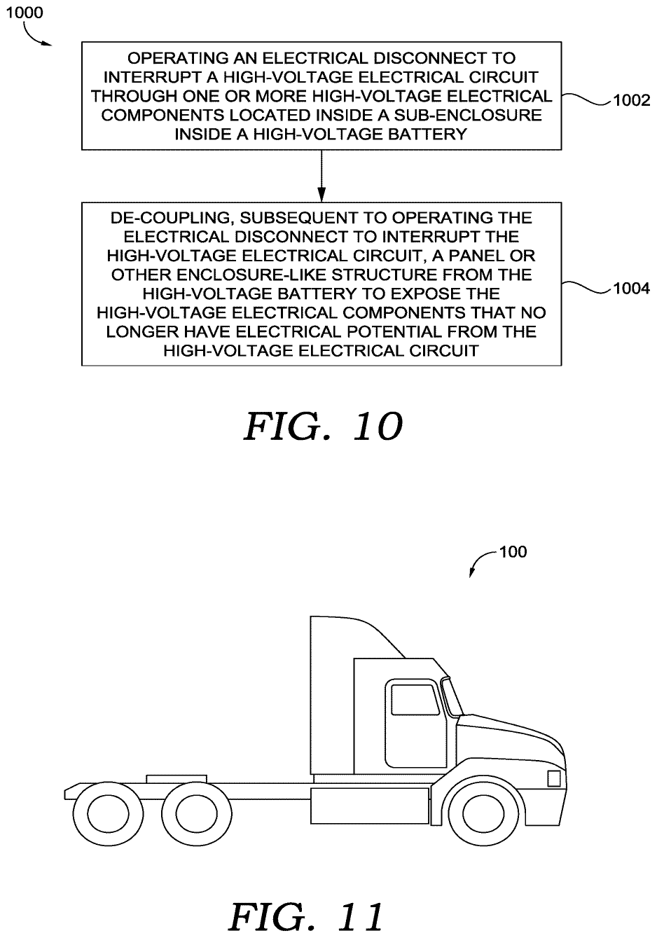

Referring to FIG. 10, a block diagram of a method 1000 of disconnecting a high-voltage electrical circuit in a battery (e.g., battery 10 depicted in FIG. 1) is shown in accordance with aspects of the present disclosure. The method 1000 includes blocks 1002-1004, but is not limited to this selection of elements or the order depicted. In block 1002, the method 1000 includes operating an electrical disconnect (e.g., electrical disconnect 34 shown in FIGS. 3 and 7) to interrupt a high-voltage electrical circuit through one or more high-voltage electrical components (e.g., the components shown in the high-voltage electronics assembly 35 of FIG. 3) located inside a sub-enclosure (e.g., sub-compartment 36 of FIG. 3) inside a high-voltage battery. In block 1004, the method 1000 includes de-coupling, subsequent to interrupting the high-voltage electrical circuit, a panel (e.g., panel 38 of FIG. 3 or panel 72 of FIGS. 8 and 9) from the high-voltage battery to expose high-voltage electrical components that no longer have electrical potential from the high-voltage electrical circuit. In aspects, the sub-compartment and electrical disconnect can be internal to the battery (e.g., accessible once an external panel of the main enclosure has been removed) or can be integrated into a panel internal to the battery or into an external portion of the battery.

Referring to FIG. 11, a mobile transport 100 is shown, in accordance with aspects of the present disclosure. The mobile transport 100 is shown for example purposes as a freight tractor. However, many other types of mobile transports are contemplated herein including cars, trucks, trams, trains, boats, aircraft, construction equipment, farming machinery, and other equipment, and the like. In aspects, a fleet of mobile transports that incorporate the aspects described herein can be provided and operated. For example, a fleet of freight trucks that are at least partially electrically propelled and that incorporate the high-voltage batteries described herein may be operated to transport cargo.

### Additional Examples of the Disclosed Technology

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.
Clause 1. An integrated high-voltage battery, comprising therein: a sub-compartment that encloses one or more high-voltage electrical components; and an electrical disconnect operable to disconnect the one or more high-voltage electrical components from a high-voltage electrical circuit prior to opening the sub-compartment.
Clause 2. The integrated high-voltage battery of clause 1, further comprising a panel forming part of a main enclosure of the battery, wherein removing the panel exposes the sub compartment and the electrical disconnect.
Clause 3. The integrated high-voltage battery of any proceeding clause, wherein the electrical disconnect comprises: a bus bar; and an electrically-insulated attachment structure that reversibly couples the bus bar to a pair of electrical contacts to thereby complete the high-voltage electrical circuit.
Clause 4. The integrated high-voltage battery of any proceeding clause, wherein the electrically-insulated attachment structure comprises a plurality of electrically-insulated fasteners that are extendable through a plurality of corresponding openings in the bus bar.
Clause 5. The integrated high-voltage battery of any proceeding clause, wherein the bus bar comprises a first portion that is electrically-conductive, and a second portion that is electrically insulated, the first portion configured to engage the pair of electrical contacts, and the second portion configured to engage the electrically-insulated attachment structure.
Clause 6. The integrated high-voltage battery of any proceeding clause, further comprising a panel that reversibly couples over the sub-compartment inside a main enclosure of the battery.
Clause 7. The integrated high-voltage battery of any proceeding clause, wherein the panel is configured such that operating the electrical disconnect to interrupt the high-voltage electrical circuit allows the panel to be de-coupled from the sub-compartment.
Clause 8. The integrated high-voltage battery of any proceeding clause, wherein the panel couples to the sub-compartment with an interlocking structure.
Clause 9. The integrated high-voltage battery of any proceeding clause, further comprising an indicator that signals interruption of the high-voltage electrical circuit in response to operation of the electrical disconnect.
Clause 10. The integrated high-voltage battery of any proceeding clause, wherein the electrical disconnect is a first electrical disconnect operable for disconnecting the high-voltage electrical circuit through the sub-compartment, and wherein the integrated high-voltage battery further comprises a second electrical disconnect operable for disconnecting the high-voltage electrical circuit through one or more battery cells.
Clause 11. The integrated high-voltage battery of any proceeding clause, wherein the electrical disconnect comprises at least one ingress-protection-rated opening.
Clause 12. An integrated high-voltage battery, comprising: an enclosure, comprising therein: a first sub-compartment that encloses one or more low-voltage electrical components; a second sub-compartment that encloses one or more high-voltage electrical components; and an electrical disconnect operable to disconnect the one or more high-voltage electrical components from a high-voltage electrical circuit and thereby allow the second sub-compartment to be opened.
Clause 13. The integrated high-voltage battery of clause 12, wherein the electrical disconnect comprises: a bus bar; and an electrically-insulated attachment structure that reversibly couples the bus bar to a pair of electrical contacts to thereby complete the high-voltage electrical circuit.
Clause 14. The integrated high-voltage battery of any proceeding clause, wherein de-coupling the bus bar from the pair of electrical contacts interrupts the high-voltage electrical circuit through the one or more high-voltage electrical components without interrupting a low-voltage electrical circuit through the one or more low-voltage electrical components.
Clause 15. The integrated high-voltage battery of any proceeding clause, wherein the first sub-compartment and the second sub-compartment are independently accessible.
Clause 16. The integrated high-voltage battery of any proceeding clause, wherein the electrical disconnect is integrated into a panel that couples over the second sub-compartment, and wherein operating the electrical disconnect to interrupt the high-voltage electrical circuit allows the panel to be de-coupled and removed and/or wherein de-coupling the panel operates the electrical disconnect.
Clause 17. The integrated high-voltage battery of any proceeding clause, wherein the panel is located inside the enclosure.
Clause 18. The integrated high-voltage battery of any proceeding clause, wherein the panel comprises part of the enclosure.
Clause 19. An integrated high-voltage battery, comprising: an enclosure; a panel that reversibly couples to the enclosure to thereby enclose one or more high-voltage electrical components; and an electrical disconnect operable for disconnecting the one or more high-voltage electrical components from a high-voltage electrical circuit, wherein operating the electrical disconnect de-couples the panel from the enclosure, and/or wherein de-coupling the panel from the enclosure operates the electrical disconnect.
Clause 20. The integrated high-voltage battery of clause 19, wherein the electrical disconnect is integrated into the panel.
Clause 21. The integrated high-voltage battery of any proceeding clause, wherein the electrical disconnect is integrated into the enclosure separate from the panel.

In some aspects, this disclosure may include the language, for example, “at least one of [element A] and [element BJ.” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some aspects, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may use the term “a” (element) or “the” (element). This language may refer to the referenced element in the singular or in the plural and is not intended to be limiting in this respect.

The subject matter of this disclosure has been described in relation to particular aspects, which are intended in all respects to be illustrative rather than restrictive. In this sense, alternative aspects will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar to those described in this disclosure, and in conjunction with other present or future technologies or solutions. Moreover, although the terms “step” or “block” may be used herein to identify different elements of methods employed, the terms should not be interpreted as implying any particular order among or between different elements except when the order is explicitly stated.

In this disclosure, reference is made to “high-voltage” batteries, components, and circuits, and “low-voltage” batteries, components, and circuits. High-voltage batteries, components, and circuits can include those that operate at about 60 volts (“V”) or higher. For example, in some aspects, high-voltage batteries, components, and circuits may operate at between about 60V-l ,200V, including any voltage therebetween. Low-voltage batteries, components, and circuits can include those that operate below about 60V.

What is claimed is:

1. An integrated high-voltage battery, comprising therein:
a sub-compartment that encloses one or more high-voltage electrical components; and
an electrical disconnect operable to disconnect the one or more high-voltage electrical components from a high-voltage electrical circuit prior to opening the sub-compartment.

2. The integrated high-voltage battery of claim 1, further comprising a panel forming part of a main enclosure of the battery, wherein removing the panel exposes the sub-compartment and the electrical disconnect.

3. The integrated high-voltage battery of claim 1, wherein the electrical disconnect comprises:
a bus bar; and
an electrically-insulated attachment structure that reversibly couples the bus bar to a pair of electrical contacts to thereby complete the high-voltage electrical circuit.

4. The integrated high-voltage battery of claim 3, wherein the electrically-insulated attachment structure comprises a plurality of electrically-insulated fasteners that are extendable through a plurality of corresponding openings in the bus bar.

5. The integrated high-voltage battery of claim 3, wherein the bus bar comprises a first portion that is electrically-conductive, and a second portion that is electrically-insulated, the first portion configured to engage the pair of electrical contacts, and the second portion configured to engage the electrically-insulated attachment structure.

6. The integrated high-voltage battery of claim 1, further comprising a panel that reversibly couples over the sub-compartment inside a main enclosure of the battery.

7. The integrated high-voltage battery of claim 6, wherein the panel is configured such that operating the electrical disconnect to interrupt the high-voltage electrical circuit allows the panel to be de-coupled from the sub-compartment.

8. The integrated high-voltage battery of claim 6, wherein the panel couples to the sub-compartment with an interlocking structure.

9. The integrated high-voltage battery of claim 1, further comprising an indicator that signals interruption of the high-voltage electrical circuit in response to operation of the electrical disconnect.

10. The integrated high-voltage battery of claim 1, wherein the electrical disconnect is a first electrical disconnect operable for disconnecting the high-voltage electrical circuit through the sub-compartment, and wherein the integrated high-voltage battery further comprises a second electrical disconnect operable for disconnecting the high-voltage electrical circuit through one or more battery cells.

11. The integrated high-voltage battery of claim 1, wherein the electrical disconnect comprises at least one ingress-protection-rated opening.

12. An integrated high-voltage battery, comprising:
an enclosure, comprising therein:
a first sub-compartment that encloses one or more low-voltage electrical components;
a second sub-compartment that encloses one or more high-voltage electrical components; and
an electrical disconnect operable to disconnect the one or more high-voltage electrical components from a high-voltage electrical circuit and thereby allow the second sub-compartment to be opened.

13. The integrated high-voltage battery of claim 12, wherein the electrical disconnect comprises:
a bus bar; and
an electrically-insulated attachment structure that reversibly couples the bus bar to a pair of electrical contacts to thereby complete the high-voltage electrical circuit.

14. The integrated high-voltage battery of claim 13, wherein de-coupling the bus bar from the pair of electrical contacts interrupts the high-voltage electrical circuit through the one or more high-voltage electrical components without interrupting a low-voltage electrical circuit through the one or more low-voltage electrical components.

15. The integrated high-voltage battery of claim 12, wherein the first sub-compartment and the second sub-compartment are independently accessible.

16. The integrated high-voltage battery of claim 12, wherein the electrical disconnect is integrated into a panel that couples over the second sub-compartment, and wherein
operating the electrical disconnect to interrupt the high-voltage electrical circuit allows the panel to be de-coupled and removed and/or wherein de-coupling the panel operates the electrical disconnect.

17. The integrated high-voltage battery of claim 16, wherein the panel is located inside the enclosure.

18. The integrated high-voltage battery of claim 16, wherein the panel comprises part of the enclosure.

19. An integrated high-voltage battery, comprising: an enclosure;
a panel that reversibly couples to the enclosure to thereby enclose one or more high-voltage electrical components; and
an electrical disconnect operable for disconnecting the one or more high-voltage electrical components from a high-voltage electrical circuit,
wherein operating the electrical disconnect de-couples the panel from the enclosure, and/or
wherein de-coupling the panel from the enclosure operates the electrical disconnect.

20. The integrated high-voltage battery of claim 19, wherein the electrical disconnect is integrated into the panel.
